(19) United States
(12) Patent Application Publication
(10) Pub. No.: US 2010/0058111 A1
(43) Pub. Date: Mar. 4, 2010

(54) ABNORMALITY DETECTION METHOD FOR ELECTRONIC DEVICE CONNECTED BY LOOP, AND ELECTRONIC DEVICE

(75) Inventor: Tomohiro Kobayashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/467,791

(22) Filed: May 18, 2009

(30) Foreign Application Priority Data
Aug. 27, 2008 (JP) 2008-218136

(51) Int. Cl. G06F 11/26; G06F 11/263

(52) U.S. Cl. 714/35; 714/37; 714/E11.159; 714/E11.177

(57) ABSTRACT

An electronic device is connected to a loop transmission line via a bypass circuit and detects being bypassed from the loop transmission line. Each electronic device connected to a looped transmission line via each bypass circuit receives a positioning map in which an own address is registered, and judges whether the own address is still registered. The electronic device can judge whether this electronic device is being bypassed from the loop transmission line by the bypass circuit using a conventional sequence.

### CROSS-REFERENCE TO RELATED APPLICATIONS

This application is based upon and claims the benefit of priority from the prior Japanese Patent Application No. 2008-218136, filed on Aug. 27, 2008, the entire contents of which are incorporated herein by reference.

### FIELD

The present invention relates to an abnormality detection method for an electronic device, so that the electronic device connected to a loop transmission line, such as FC_AL, detects being bypassed from the loop transmission line, and an electronic device, and more particularly to an abnormality detection method for an electronic device, so that the electronic device detects being bypassed from the loop transmission line and failure analysis can be simplified, and an electronic device.

### BACKGROUND

A loop transmission line is widely used lately for connecting a host device and peripheral devices. For example, FC_AL (Fibre Channel Arbitrated Loop) is known as a loop transmission line.

In particular, in storage systems connected to a host device, a configuration of connecting a storage controller and many magnetic disk devices via FC_AL is widely used.

Each magnetic disk device is connected to a port bypass circuit (PBC) disposed on this loop transmission line. The PBC not only connects each magnetic disk device to the loop transmission line, but also bypasses (disconnects) each connected magnetic disk device based on instructions from the storage controller. The loop transmission line and PBC are installed on the back plane (back board), and a magnetic disk device is removably installed on the back plane (e.g. Japanese Patent Application Laid-Open No. 2003-158526, Japanese Patent Application Laid-Open No 2001-45035 and Japanese Patent Application Laid-Open No 2000-59414).

In this storage system connected via FC-AL, having a port bypass circuit (PBC) on the back plane, a magnetic disk device on the loop may be bypassed for any reason. For example, if a response is not received from a magnetic disk device to an inquiry or command from the controller, or if the response time is long, or if an error keeps returning, the controller sets the PBC, to which this magnetic device is connected, to bypass state, so as to disconnect this magnetic disk device.

In order to specify a cause of this bypass state, both the system (controller, transmission line) and the magnetic disk device must be checked so that failure of the system or of the magnetic disk device can be discerned. However, in the case of prior art, the controller recognizes the bypass of the magnetic disk device, but the magnetic disk device does not recognize being bypassed on the back plane.

Therefore the magnetic disk device cannot find a trigger to perform logging the internal information required for subsequent failure analysis, and it often takes a long time to detect the cause of bypass in the investigation of the magnetic disk device.

### SUMMARY

With the foregoing in view, it is an object of the present invention to provide an abnormality detection method for an electric device, so that an electronic device connected via a loop transmission line detects being bypassed from the loop transmission line, and the electronic device.

It is another object of the present invention to provide an abnormality detection method for an electronic device, so that an electronic device connected via a loop transmission line detects being bypassed from the loop transmission line, and collects information required for failure analysis, and the electronic device.

It is still another object of the present invention to provide an abnormality detection method for an electronic device, so that an electronic device connected via a loop transmission line detects being bypassed from the loop transmission line by using a protocol of the loop transmission line, and the electronic device.

An abnormality detection method for an electronic device connected by a loop in one mode of the invention to attain the above objects includes the steps of: receiving a positioning map frame for registering an address on the loop transmission line from the loop transmission line by each one of a plurality of electronic devices connected to a loop transmission line via a bypass circuit constructing a loop configuration; storing and updating an own address in the received positioning map frame by said each of the electronic devices; sending the updated positioning map frame to the loop transmission line via the bypass circuit to construct a loop configuration by said each of the electronic devices; receiving the positioning map frame updated after one round of the loop transmission line with the electronic device; judging whether the stored own address exists in the received positioning map by the electronic device; and judging being bypassed from the loop transmission line by the bypass circuit when the electronic device judges that the stored local address does not exist in the received positioning map.

An electronic device connected to a loop transmission line via a bypass circuit, in one mode of the present invention to attain the above objects includes: a receive circuit which receives a signal from the loop transmission line; a transmission circuit which sends a signal to the bypass circuit; and a control circuit which executes loop initialization processing for receiving a positioning map frame for registering an address on the transmission line, storing and updating an own address in the received positioning map frame, and sending the updated positioning map frame to the loop transmission line via the bypass circuit, wherein the control circuit receives the positioning map frame updated after one round of the loop transmission line, judges whether the stored own address exists in the received positioning map, and determines being bypassed from the loop transmission line by the bypass circuit when judging that the stored own address does not exist in the received positioning map.

Since the electronic device receives the positioning map in which the own address is registered in the loop initialization processing of the loop transmission line, and judges whether the own address is still registered, the looped electronic device can determines whether this electronic device is being bypassed from the loop transmission line by the bypass circuit using a conventional sequence.

### BRIEF DESCRIPTION OF DRAWINGS

FIG. 1 is a block diagram depicting an embodiment of a system using a loop transmission line according to the present invention;

FIG. 2 is a diagram depicting a magnetic disk device in FIG. 1 and a back plane thereof;

FIG. 3 shows a connecting state in the magnetic disk device in FIG. 1;

FIG. 4 shows a bypassing state the magnetic disk device in FIG. 1;

FIG. 5 is a block diagram depicting an embodiment of the electronic device in FIG. 1;

FIG. 6 is a diagram depicting a format of a positioning map frame used in the looped initialization processing of a loop transmission line in FIG. 1;

FIG. 7 is a flow chart depicting a receiving processing of the LIRP frame in the electronic device in FIGS. 1 and 5;

FIG. 8 shows a LIRP frame in the connected state in the electronic device shown in FIG. 3;

FIG. 9 shows a LIRP frame in the bypassing state in the electronic device shown in FIG. 4;

FIG. 10 is a flow chart depicting the first embodiment of the abnormal detection processing of the present invention;

FIG. 11 shows the data to be corrected for the abnormality detection processing in FIG. 10; and

FIG. 12 is a flow chart depicting the second embodiment of the abnormal detection processing of the present invention.

### DESCRIPTION OF EMBODIMENTS

Embodiments of the present invention will now be described in the sequence of a system using a loop transmission line, electronic device, first embodiment of abnormality detection processing, and second embodiment of abnormality detection processing, but the present invention is not limited to these embodiments.

(System Using Loop Transmission Line)

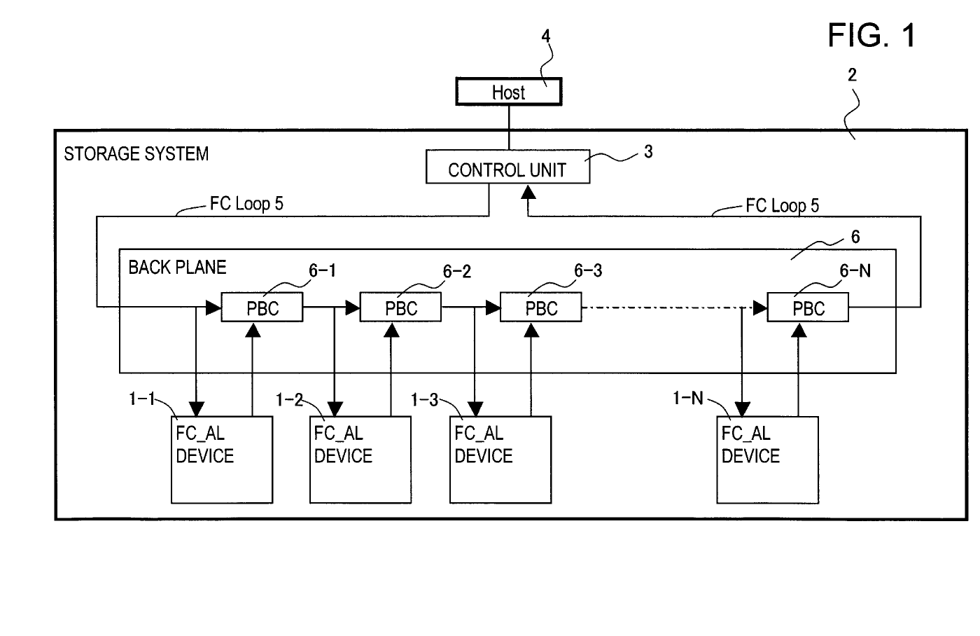

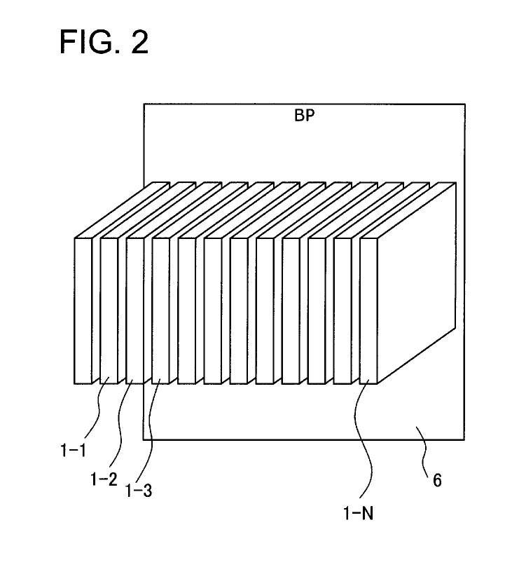

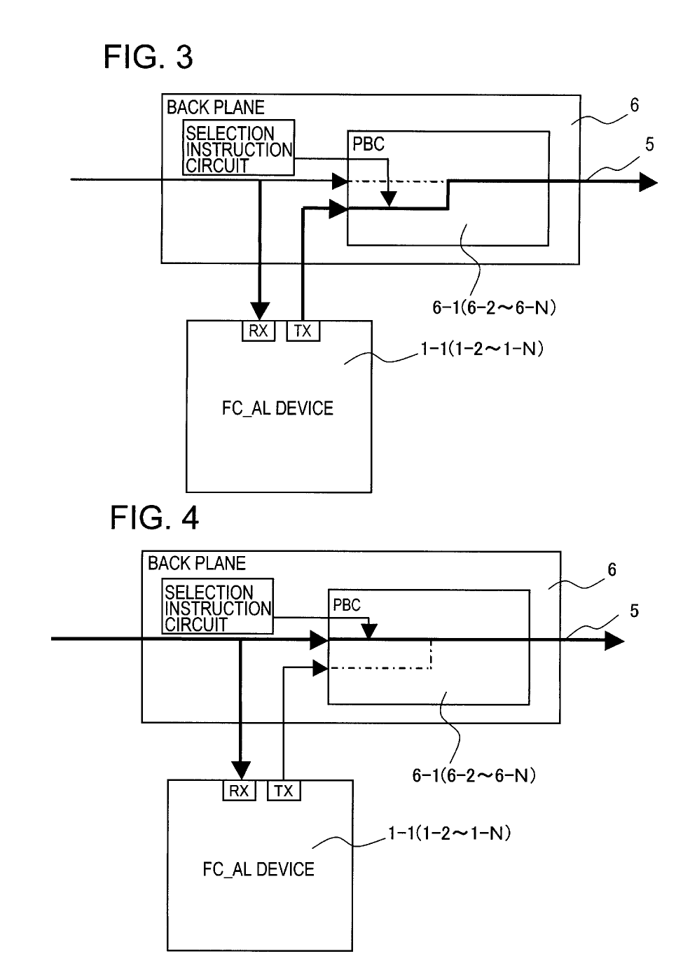

FIG. 1 is a block diagram depicting an embodiment of a system using a loop transmission line according to the present invention, FIG. 2 is a diagram depicting a back plane thereof, and FIG. 3 and FIG. 4 are diagrams depicting PBC in FIG. 1. FIG. 1 shows a storage system as an example of the system, and FC_AL as an example of the loop transmission line.

As FIG. 1 shows, a storage system 2 is connected to a host 4, and processes a read/write request from the host 4. The storage system 2 has a control unit 2, a plurality of FC_AL devices (magnetic disk devices in this case) 1-1 to 1-N, an FC (Fibre Channel) loop 5, and port bypass circuits (PBC) 6-1 to 6-N for connecting/bypassing each FC_AL device 1-1 to 1-N to the FC loop 5.

As FIG. 2 also shows, the PBC 6-1 to 6-N are disposed on a back plane 6. Each FC_AL device 1-1 to 1-N is connected to the back plane 6 via a connector, thereby connected to each PBC 6-1 to 6-N on the back plane 6.

As FIG. 3 and FIG. 4 show, each FC_AL device 1-1 to 1-N has a receiver RX connected to the FC loop 5, and a transmitter TX connected to each PBC 6-1 to 6-N.

Each PBC 6-1 to 6-N is constituted by a switch having two inputs and one output. Each PBC 6-1 to 6-N selects either the FC loop 5 or each FC_AL device 1-1 to 1-N, as an input, and outputs it to the FC loop 5. FIG. 3 shows a connection state of PBC during normal operation, where the transmitter TX of the FC_AL device 1-1 to 1-N is connected to the FC loop 5.

FIG. 4 shows a connection state of PBC during bypass operation, where PBC is connected to the FC loop 5 bypassing the FC_AL devices 1-1 to 1-N. As mentioned above, if a FC_AL device does not respond to an inquiry or command from the controller 3, or if the response time is long, or if an error keeps returning, the controller 3 (see FIG. 1) sets the PBC to which this FC_AL device (magnetic disk device) is connected to the bypass state, so as to disconnect this magnetic disk device. At this time, the FC_AL device cannot recognize being bypassed.

(Electronic Device)

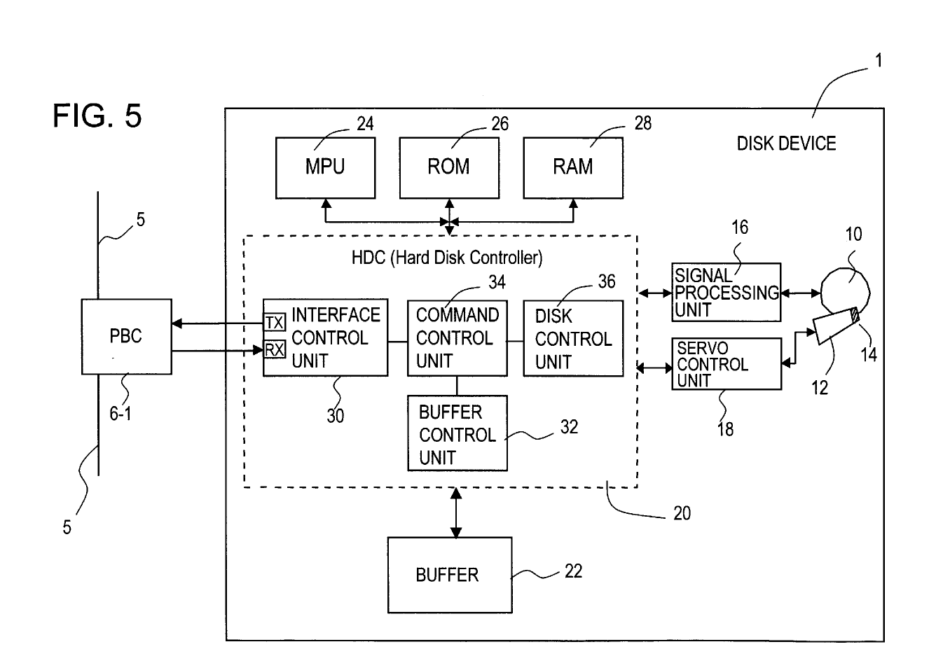

FIG. 5 is a block diagram depicting an embodiment of the electronic device connected via FC_AL according to the present invention, and shows a magnetic disk device as an example of the electronic device.

As FIG. 5 shows, the magnetic disk device 1 has a drive mechanism (disk enclosure) and a print circuit assembly (PCA). In the disk enclosure (DE), a magnetic disk 10, which is a magnetic recording media, is mounted on a rotation axis of a spindle motor (not illustrated). The spindle motor rotates the magnetic disk 10. The actuator (VCM) 12 has an arm (head actuator) and a magnetic head 14 at the tip of the suspension, and moves the magnetic head 14 in the radius direction of the magnetic disk 10.

The actuator 12 is constituted by a voice coil motor (VCM) which rotates around the rotation axis. The magnetic head 14 is constituted by a read element and a write element.

In the print circuit assembly (control circuit unit), a hard disk controller (HDC) 20, a microprocessor (MPU) 24, a signal processing circuit (read channel circuit: RDC) 16, a servo control circuit 18, a data buffer (RAM) 22, a ROM (Read Only Memory) 26 and RAM 28 are disposed.

The read channel circuit (RDC) 16 includes a preamplifier, and controls the data read and data write of the magnetic head 14. In other words, RDC 16 performs data modulation, data demodulation and signal amplification. The servo control circuit (SVC) 18 drives and controls the spindle motor, and also drives and controls the VCM 12.

The hard disk controller (HDC) 20 has an interface control circuit 30 which controls the interface, a command control circuit 34 which performs control according to a command from the host, a data buffer control circuit 32 which controls the data buffer 22, and a disk control circuit 36 which controls disk format. The data buffer (RAM) 22 temporarily stores read data and write data.

The micro processor (MPU) 24 controls the HDC 36, and manages the RAM 28 and ROM 26. The ROM 26 stores various programs and parameters. The RAM 28 stores various data required for processing by the MPU 24.

As FIG. 3 and FIG. 4 show, the interface control circuit 30 is connected with the PCB via the interface 5 of the FC_AL. The interface control circuit 30 is constituted by a physical layer, such as a transmitter TX and receiver RX, a link layer, and a protocol control layer (logical layer).

### First Embodiment of Abnormality Detection Processing

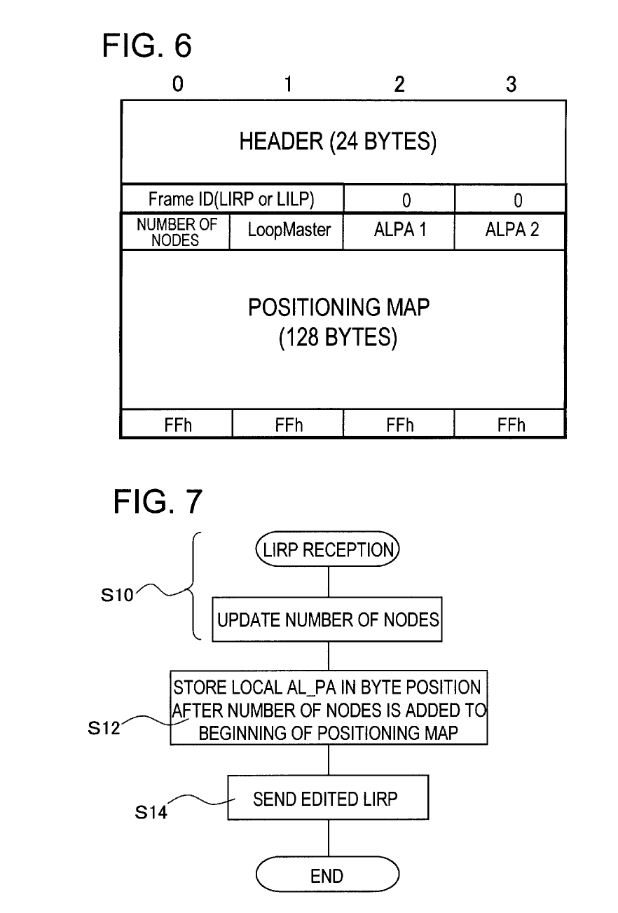

FIG. 6 is a diagram depicting a format of a positioning map frame used for an embodiment of the abnormality detection of the present invention, and FIG. 7 is a flow chart depicting an update processing according to an embodiment of the abnormality detection of the present invention.

Under the FC_AL environment, an initialization procedure (Loop Initialize) is performed for constructing a loop configuration. When Loop Initialize (loop construction) completes, a positioning map frame (LIRP: Loop Initialization Report Position and LILP: Loop Initialization Loop Position) which stores a physical address for identifying a node (AL-PA: Arbitrated Loop Physical Address) is transferred between nodes (magnetic disk devices to be an initiator and a target) on the loop.

As FIG. 6 shows, the positioning map frame is a map for storing the number of nodes of a constructed loop, Loop Master and AL_PA of each node, whereby a node in the loop can be recognized between nodes connected by the loop. A header and frame ID (LIRP or LILP) are also set.

The transfer processing of each node will now be described with reference to FIG. 7.

(S10) A predetermined loop master sends the positioning map for reporting LIRP in FIG. 6 to the FC loop 5. An FC_AL node (magnetic disk device 1 in FIG. 5) receives the LIRP from the FC loop 5 via the receiver RX of the interface control unit 30, and the command control unit 34 updates the number of nodes in the received LIRP.

(S12) The command control unit 34 registers (stores) the own AL_PA in a byte position after the blank for the number of nodes from the loop master of the LIRP (FIG. 6).

(S14) The command control unit 34 sends the edited LIRP to the FC loop 5, via the transmitter TX of the interface control unit 30. And the reporting processing ends.

In this way, AL-PA is registered in the positioning map frame (LIRP) in the sequence of connected nodes, with the loop master first, and the positioning map frame is sent to the next node. When the LIRP frame returns to the loop master, (all the nodes complete registration of AL_PA), the loop master resends this frame as the LILP frame.

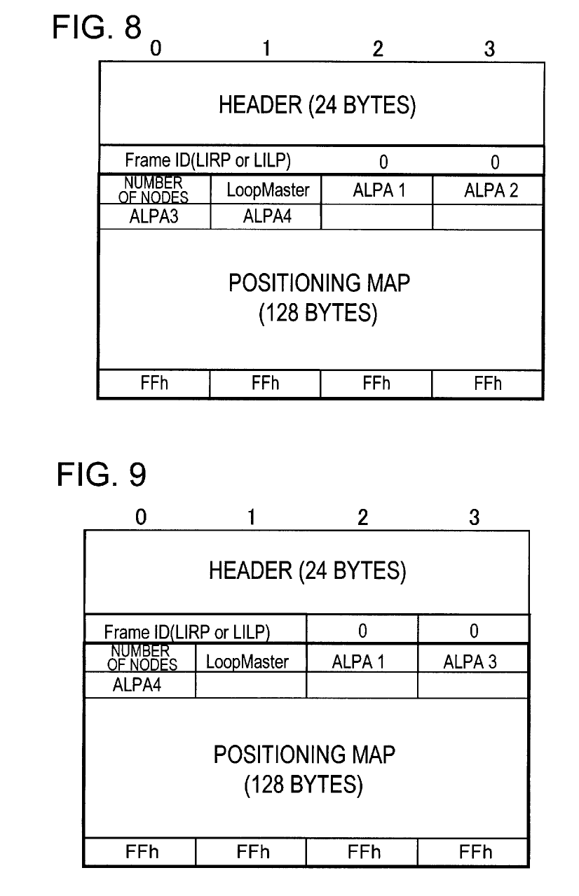

If the FC_AL device 1-1 is not bypassed on the back plane as shown in FIG. 3, input from the FC loop 5 can be received and output can be propagated on the loop, so as FIG. 8 shows, the FC_AL device can receive the LIRP frame, update the positioning map LIRP, send the updated positioning map LIRP to the FC loop 5, and transfer it to the next node (FC_AL device), as shown in FIG. 7.

If the FC_AL device is bypassed on the back plane as shown in FIG. 4, on the other hand, input from the FC loop 5 can be received, but output cannot be propagated on the FC loop 5.

The bypassed node receives the LIRP frame and updates the positioning map, but cannot send the updated LIRP frame to the FC loop 5. Therefore the LIRP which returned to the loop master shows that the position where the own AL-PA should be registered is replaced with the AL_PA of another node, or is still in an unregistered state (0xFF is written), as shown in FIG. 9.

In the case of the example in FIG. 9, the FC_AL device of AL_PA2 is bypassed, so the next node, AL_PA3, is registered in the position where “AL_PA2” should be registered.

Since the updated LIRP frame is resent from the loop master as the LILP frame, the magnetic disk device which received the LILP frame checks whether the own AL_PA exists in the positioning map in the frame, and if it does not exist, the magnetic disk device judges that this magnetic disk device is being bypassed on the back plane, and performs processing required for subsequent failure analysis.

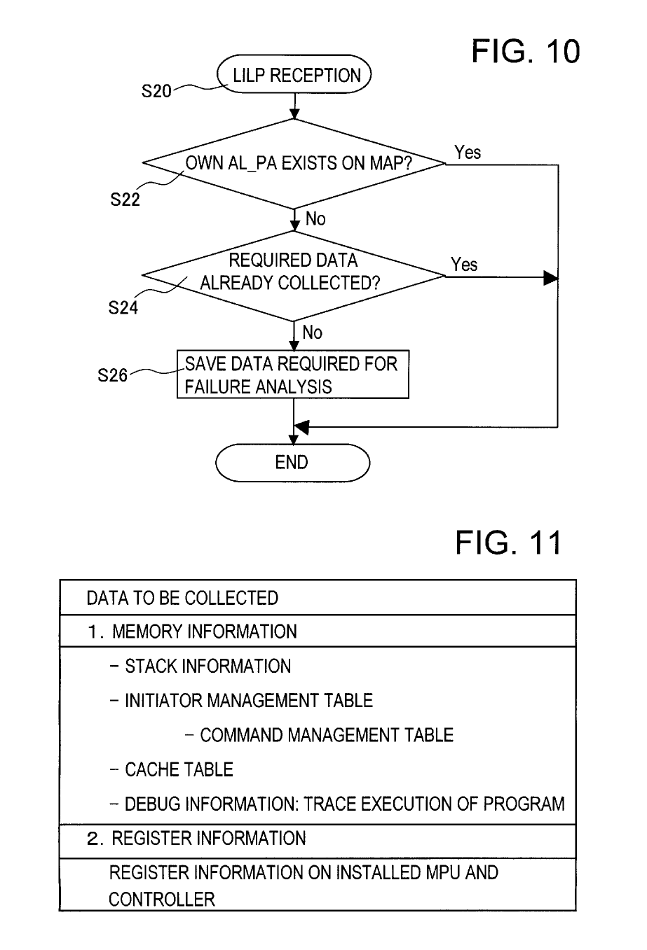

FIG. 10 is a flow chart depicting an abnormality detection processing flow according to an embodiment of the present invention, and FIG. 11 shows the data to be corrected for the abnormality detection processing. In this example, the internal state is saved as a processing required for the failure analysis.

(S20) When the FC_AL node (magnetic disk device 1 in FIG. 5) receives LILP via the receiver PX of the interface control unit 30 from the FC loop 5, the command control unit 34 confirms that the received frame is LILP.

(S22) If the received frame is LILP, the command control unit 34 transfers the received LILP frame to the MPU 24. The MPU 24 confirms whether the own AL-PA exists in the same position of the positioning map registered when the LIRP frame is received. If it exists, the MPU 24 ends this confirmation processing.

(S24) If it is judged that the own AL_PA does not exist in the LILP frame (abnormality), the MPU 24 confirms whether the required processing (data collection) for checking has already been performed. This processing is for maintaining the state immediately after the bypassing. If data collection has been performed, the MPU 24 ends this confirmation processing.

(S26) If the required processing has not yet been performed, the MPU 24 performs this processing, and prepares for the subsequent check. In the case of this example, data collection processing is performed, and the data shown in FIG. 11 is collected.

In FIG. 11, the stacked information, initiator management table, command management table, cache table, and debug information (tracing program execution: path passed and data handled during program execution for debugging) are collected as the memory information. As the register information, register information on the installed MPU and controllers is collected. This information is stored in the collection area in the system area (SA area) on the media.

When this processing ends, the MPU 24 sends the LIRP frame received from the command control unit 34 and the interface control unit 30 to the FC loop 5.

In this way, the positioning map is updated with the own address, and when the updated positioning map is retransmitted, it is judged whether this own address exists in the positioning map, thereby it can be judged whether this device is bypassed from the FC loop or not. This means that it can be judged whether the device is bypassed or not using a conventional initialization sequence.

Since bypass is detected and the data required for failure analysis is collected in advance, the data required for analysis can be easily acquired when the magnetic disk device is disconnected from the back plane, and is analyzed using a failure diagnosis device, as shown in FIG. 2.

Therefore the cause of bypass can be analyzed by a magnetic disk device alone, and a check to discern whether the cause is the system or the disk can be easily performed.

In summary, an abnormality detection method for a looped electronic device, so that an electronic device connected via a loop transmission line detects being bypassed from the loop transmission line by using a protocol of the loop transmission line, and the electronic device.

An abnormality detection method for an electronic device connected by a loop includes the steps of: receiving a positioning map frame for registering an address on the loop transmission line from the loop transmission line by each one of a plurality of electronic devices connected to a loop transmission line via a bypass circuit constructing a loop configuration; storing and updating an own address in the received positioning map frame by said each of the electronic devices; sending the updated positioning map frame to the loop transmission line via the bypass circuit to construct a loop configuration by said each of the electronic devices; receiving the positioning map frame updated after one round of the loop transmission line with the electronic device; judging whether the stored own address exists in the received positioning map by the electronic device; and judging being bypassed from the loop transmission line by the bypass circuit when the electronic device judges that the stored local address does not exist in the received positioning map.

The abnormality detection method for a looped electronic device further includes a step of saving internal data required for failure analysis when the electronic device judges being bypassed from the loop transmission line by the bypass circuit.

The loop transmission line is constructed as FC_AL, and the positioning map frame is sent from the loop master on the loop transmission line.

The saving step further has a step of judging whether the internal data required for failure analysis has already been saved, when it is judged that the electronic device is bypassed from the loop transmission line by the bypass circuit, and a step of saving the internal data, when the electronic device judges that the internal data has not yet been saved.

The electronic device is constructed as a storage device for storing data. The storage device is constructed as a magnetic disk device.

### Second Embodiment of Abnormality Detection Processing

A second embodiment of an abnormality detection processing according to the present invention will now be described. In the first embodiment, this magnetic disk device can recognize being bypassed only when Loop Initialize is generated.

A magnetic disk device recognizing its bypass state promptly is effective for early diagnosis. According to the second embodiment, another disk device monitors the state and issues LIP (generates Loop Initialize) when bypass is detected, so that the magnetic disk device can recognize the situation without fail at an early stage.

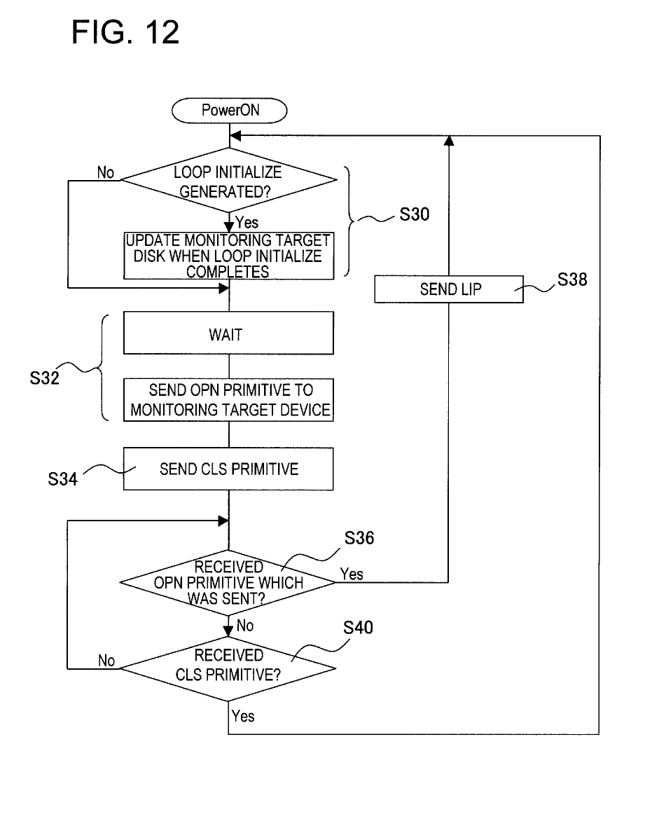

FIG. 12 is a flow chart depicting the second embodiment of the abnormal detection processing of the present invention.

(S30) The MPU 24 of the magnetic disk device 1 judges whether Loop Initialize was generated. In other words, it is judged whether the LIRP frame was received. If it is judged that Loop Initialize was generated, the MPU 24 sets the next magnetic disk device upstream as the monitoring target, based on the LILP frame when Loop Initialize completes, and stores the AL_PA of this magnetic disk.

(S32) When a predetermined time elapses, each magnetic disk device 1 on the FC loop periodically sends an open (OPN) primitive to the monitoring target magnetic disk device from the FC loop 5. The open primitive is a communication start primitive which is transferred to the FC loop 5 with specifying a transmission source and a transmission destination, and only the transmission source and transmission destination nodes can filter (receive) the open primitive.

(S34) After each magnetic disk device sends the OPN primitive, each magnetic disk device sends a close (CLS) primitive to the monitoring target magnetic disk device via the FC loop 5. The close primitive is a communication completion primitive to be transferred to the FC loop 5, with specifying a transmission source and a transmission destination, and only the transmission source and transmission destination nodes can filter (receive) the close primitive.

(S36) The magnetic disk device which sent the OPN primitive judges whether the OPN primitive, sent by this magnetic disk device, is received from the FC loop 5.

(S38) If this magnetic disk device receives the OPN primitive sent by this magnetic disk device from the FC loop 5 (OPN primitive returned from the FC loop 5), the magnetic disk device which sent the OPN primitive determines that the monitoring target magnetic disk device is bypassed, and issues LIP (Loop Initialize Primitive) to the FC loop 5.

By this, each magnetic disk device connected to the FC loop 5 moves to the loop initialization sequence. In the loop initialization sequence, a loop master is determined and the procedure in the first embodiment is executed. In other words, an LIRP frame is sent from the master node to the FC loop 5, the positioning map of the LIRP frame is updated by each node on the loop, and when the positioning map is returned to the loop master, this positioning map is sent from the loop master to the FC loop 5 as an LILP frame.

Just like the first embodiment, this magnetic disk device detects being bypassed by this LILP frame according to the processing flow in FIG. 10. The monitoring target of the magnetic disk device which issued the LIP is changed after Loop Initialize is completed.

(S40) The magnetic disk device which sent the OPN primitive judges that the CLS primitive sent by this magnetic disk device is received (the CLS primitive is returned from the FC loop 5), when the OPN primitive sent by this magnetic disk is not received from the FC loop 5. In other words, it is judged whether the CLS primitive returned first.

If it is judged that the CLS primitive is received, it is judged that the monitoring target magnetic disk device is not bypassed (exists on the loop), and the monitoring processing ends, and processing returns to step S30.

Since only the transmission source and transmission destination nodes can filter the OPN primitive, the transmission destination does not return the OPN primitive to the FC loop if the OPN primitive is received.

If the transmission destination is bypassed, however, the OPN primitive is returned from the FC loop 5 to the transmission source. Hence whether the transmission destination node exists on the loop or not can be judged depending on whether the OPN primitive is returned.

The FC loop is not continuously occupied since the occupation of the FC loop is released by sending the CLS primitive, thereby interfering with the communication of other nodes can be prevented.

Such monitoring processing is repeated by each magnetic disk device with a predetermined interval, so as to monitor another magnetic disk device on the loop respectively. As a result, the bypass state of the magnetic disk device can be detected soon by itself, and effective diagnosis and analysis is implemented.

In summary, the electronic device sends an open primitive, which can be used only by a transmission source and transmission destination, to another electronic device on the loop transmission line, via the loop transmission line, judges whether the open primitive is received from the loop transmission line, and judges that the other electronic device is bypassed from the loop transmission line by the bypass circuit, and starts the loop initialization processing when it is judged that the open primitive is received from the loop transmission line.

The monitoring step includes a step of sending a close primitive to the other electronic device after sending the open primitive, and a step of judging that the other electronic device is not bypassed from the loop transmission line by the bypass circuit when it is judged that the close primitive is received without receiving the open primitive from the loop transmission line.

### Other Embodiments

In the above embodiments, the electronic device was described using the magnetic disk device as an example, but the present invention can also be applied to another device connected to a loop transmission line (e.g. other media storage devices, such as an optical disk device, communication device, display device and printer). The loop transmission line was described using FC_AL, but the present invention can also be applied to other loop transmission lines.

As described above, embodiments of the present invention were explained, however, it should be understood that we intend to cover by the appended claims all modifications falling within the true spirit and scope of the invention.

Since the positioning map in which a own address is registered is received in the loop initialization processing of the loop transmission line, and it is judged whether the own address is still registered, the looped electronic device can judge whether this electronic device is being bypassed from the loop transmission line by the bypass circuit using a conventional sequence.

1. An abnormality detection method for an electronic device which is connected by a loop, comprising the steps of:
receiving a positioning map frame for registering an address on a loop transmission line from the loop transmission line by each of a plurality of the electronic device which is connected to the loop transmission line via a bypass circuit;
storing and updating an own address in the received positioning map frame, and sending the updated positioning map frame to the loop transmission line via the bypass circuit;
receiving the positioning map frame updated after one round of the loop transmission line by said each electronic devices;
judging whether the stored own address exists in the received positioning map; and
determining being bypassed from the loop transmission line by the bypass circuit when the electronic device judges that the stored own address does not exist in the received positioning map.

2. The abnormality detection method for an electronic device according to claim 1, further comprising a step of saving internal data required for failure analysis when the electronic device judges being bypassed from the loop transmission line by the bypass circuit.

3. The abnormality detection method for an electronic device according to claim 1, further comprising:
a monitoring step that the electronic device sends an open primitive, which can be used only by a transmission source and transmission destination, to another electronic device on the loop transmission line, via the loop transmission line, and the electronic device judges whether the open primitive is received from the loop transmission line; and
a step that the electronic device judges that the other electronic device is bypassed from the loop transmission line by the bypass circuit, and starts the loop configuration construction step when it is judged that the open primitive is received from the loop transmission line.

4. The abnormality detection method for an electronic device according to claim 1, wherein the loop transmission line is constructed as FC_AL, and the positioning map frame is sent from a loop master on the loop transmission line.

5. The abnormality detection method for an electronic device according to claim 2, wherein the saving step comprises the steps of:
judging whether the internal data required for failure analysis has already been saved when it is judged that the electronic device is bypassed from the loop transmission line by the bypass circuit; and
saving the internal data when it is judged that the internal data has not been saved.

6. The abnormality detection method for an electronic device according to claim 3, wherein the monitoring step comprises the steps of:
sending a close primitive from the electronic device to the other electronic device after sending the open primitive; and
judging that the other electronic device is not bypassed from the loop transmission line by the bypass circuit when it is judged that the close primitive is received without receiving the open primitive from the loop transmission line.

7. The abnormality detection method for an electronic device according to claim 1, wherein the electronic device is constructed as a storage device for storing data.

8. The abnormality detection method for an electronic device according to claim 7, wherein the storage device is constructed as a magnetic disk device.

9. An electronic device, connected to a loop transmission line via a bypass circuit, comprising:
a receive circuit for receiving a signal from the loop transmission line;
a transmission circuit for sending a signal to the bypass circuit; and
a control circuit which executes loop initialization processing for receiving a positioning map frame for registering an address on the transmission line, storing and updating an own address in the received positioning map frame, and sending the updated positioning map frame to the loop transmission line via the bypass circuit,
wherein the control circuit receives the positioning map frame updated after one round of the loop transmission line, judges whether the stored own address exists in the received positioning map, and determines being bypassed from the loop transmission line by the bypass circuit when it is judged that the stored own address does not exist in the received positioning map.

10. The electronic device according to claim 9, wherein the control circuit saves internal data required for failure analysis when it is judged that the electronic device is bypassed from the loop transmission line by the bypass circuit.

11. The electronic device according to claim 9, wherein the control circuit sends an open primitive, which can be used only by a transmission source and transmission destination, to another electronic device on the loop transmission line, via the loop transmission line, judges whether the open primitive is received from the loop transmission line, and determines that the other electronic device is bypassed from the loop transmission line by the bypass circuit, and starts the loop initialization processing when it is judged that the open primitive is received from the loop transmission line.

12. The electronic device according to claim 9, wherein the loop transmission line is constructed as FC_AL, and the positioning map frame is sent from a loop master on the loop transmission line.

13. The electronic device according to claim 9, wherein the control circuit judges whether the internal data has already been saved when it is judged that the electronic device is bypassed from the loop transmission line by the bypass circuit, and saves the internal data when it is judged that the internal data has not been saved.

14. The electronic device according to claim 9, wherein the control circuit sends a close primitive to the other electronic device after sending the open primitive, and judges that the other electronic device is not bypassed from the loop transmission line by the bypass circuit when it is judged that the close primitive is received without receiving the open primitive from the loop transmission line.

15. The electronic device according to claim 9, wherein the electronic device is constructed as a storage device for saving data.

16. The electronic device according to claim 9, wherein the storage device is constructed as a magnetic disk device.

17. The electronic device according to claim 9, wherein the electronic device can be connected to or disconnected from a back plane on which the loop transmission line and the bypass circuit are installed.
